(19) United States
(12) Patent Application Publication
(10) Pub. No.: US 2010/0116847 A1
(43) Pub. Date: May 13, 2010

(54) UNDER-COUNTER WATER COOLER APPLIANCE

(75) Inventors: Parvaneh Movahed Foroughi, Basking Ridge, NJ (US); Khosrow Foroughi, Basking Ridge, NJ (US); Peter Byar, Willingboro, NJ (US); John Coleman, Philadelphia, PA (US); Andrew Weiman, Langhorne, PA (US)

Correspondence Address: VENABLE LLP, P.O. BOX 34385, WASHINGTON, DC, 20043-9998, US

(73) Assignee: Design By Pari, LLC, Basking Ridge, NJ (US)

(21) Appl. No.: 12/615,046

(22) Filed: Nov. 9, 2009

Related U.S. Application Data
(60) Provisional application No. 61/112,299, filed on Nov. 7, 2008.

(51) Int. Cl. B67D 7/84

(52) U.S. Cl. 222/81; 222/173; 222/146.1; 222/160

(57) ABSTRACT

An appliance for dispensing a liquid to a user, including an appliance base cabinet comprising an enclosure positioned under a counter that is fixed to a wall. The appliance base cabinet having a support member that is moveable relative to the counter. At least one dispenser spigot is coupled to the appliance base cabinet at a suitable distance below the counter to allow a user dispense water via the at least one dispenser spigot. At least one liquid storage tank is supported by the support member having an opening for out-flow of the liquid. The at least one liquid storage tank is accessible for removal or installation when the support member is moved away from the kitchen counter. The appliance further includes an intermediate reservoir within the appliance base cabinet under the kitchen counter coupled to the opening of the at least one liquid storage tank through which the liquid out of the at least one liquid storage tank is channeled to the at least one dispenser spigot.

### CROSS-REFERENCE TO RELATED APPLICATION

This application claims the priority of Provisional Application No. 61/112,299, filed on Nov. 7, 2008, the subject matter of which is incorporated herein by reference.

### FIELD OF THE INVENTION

This invention relates generally to liquid dispensers, and in particular, to drinking liquid dispensers for bottled liquids in which the bottle is housed in a modular appliance base cabinet located beneath a kitchen counter.

### BACKGROUND OF THE INVENTION

The distribution of bottled liquids is widely used in offices and homes throughout the world. For example, U.S. Pat. No. 2,744,660 to Jacobs discloses an apparatus for displaying and dispensing fruit juices, milk, and similar beverages in a tank preferably made of glass or other transparent material, mounted on a cabinet. A dispensing valve controlled by a handle, is mounted on the side of the cabinet and connected by piping to the tank.

U.S. Pat. No. 3,269,143 to Gasparovich discloses a liquid cooling unit in which a liquid supply bottle is positioned in the bottom of a unit and remains in the upright position. The water cooler is generally comprised of a cabinet having a compartment in its lower portion. A removable liquid reservoir is positioned within the compartment. A door vertically mounted and pivoting on a hinge provides access to the compartment.

U.S. Pat. No. 3,572,553 to Ogden discloses an attachment unit capable of being used with water dispensers. The unit includes a housing and an apparatus to sense the water level in a reservoir. A replenishing means is coupled to ordinary tap water inlets, or can be coupled to a liquid filter device.

U.S. Pat. No. 4,830,223 to Priest discloses a water sending and dispensing system that includes a cabinet in which a water container is disposed. A draw tube and a refill tube are sealably inserted through a filtered opening of a water container. The upper end of the refill tube is attached to a refill chamber that allows the easy refill of the container. An upper end of the suction tube is connected to an inlet of a pump. An outlet of the pump delivers water to the exterior. This water is preferably delivered at an elevated pressure.

U.S. Pat. No. 4,923,091 to Sutera discloses a self-filling bottled-water cooler that dispenses pure water from a transparent water bottle mounted on the top of a free-standing cabinet body. A free-standing cabinet body includes a water tank located within the upper body of the cabinet body and at least one tap for dispensing water from the water tank. The water bottle is securely attached on the top of the cabinet body to the water tank such that the water freely flows between the bottle and the tank.

U.S. Pat. No. 4,958,747 to Sheets discloses a dispenser for housing large (for example, 5-gallon) bottled drinking water containers having a generally narrow mouth. The dispenser includes a cabinet having a lower end portion adapted to receive the bottle in an upright fashion and the upper mouth portion extends upwardly. A pump suctions water from the bottle and transmits it to an ambient temperature reservoir for containing ambient temperature water such as is typically used in cooking or the like. A second cold water reservoir receives flow via a duct which extends through the central portion of the second reservoir. The duct transmits ambient water to the second reservoir and beyond to a spigot which is affixed to the external cabinet portion of the apparatus. A second spigot transmits cold water from a second reservoir.

U.S. Pat. No. 5,495,725 to Middlemiss discloses a system that automatically transfers water from an upright water bottle below a reservoir to the reservoir whenever water in the reservoir falls below a predetermined level. A water pipe carries the water from the bottle, through a sealed closure in the bottle neck and up into the reservoir. An air pump in a housing atop the reservoir generates air pressure in an air tube passing through the closure and into the bottle.

U.S. Pat. No. 5,540,355 to Hancock et al. discloses a water cooler and dispensing system that includes a housing, a pump, a cap, a siphon tube, a reservoir, a cooling unit, control circuitry and a faucet. The housing includes a frame and detachable panels for supporting a reservoir above a water bottle. The cap substantially seals the bottle and is coupled to the pump. The pump forces air into the bottle and water upward through the siphon tube to the reservoir. The reservoir is divided into two portions, and the lower portion contains a cooling unit for chilling the water. An output port from each portion of the reservoir is coupled to a faucet formed by a manifold, two valves and a nozzle. The dispenser also includes control circuitry for selectively operating the pump to maintain a predetermined water level in the reservoir. The controller also lights an indicator when the bottle is empty.

U.S. Pat. No. 6,056,154 to Fowler discloses a fluid dispensing system for receiving fluid from a container positioned near the ground and for transporting the water up to a reservoir suitable for dispensing. The system has a cabinet having first and second chambers. A slidable support base is mounted in the first chamber to support a container for storing fluid. A reservoir is mounted in the second chamber, the reservoir further having a spigot to dispense the fluid upon request. The system has a pump for transporting fluid from the container to the reservoir and a circuit connected to the pump and to the sensor for activating the pump when fluid in the reservoir falls below the predetermined fluid level.

These known fluid dispensing systems suffer from a number of drawbacks which makes them unsuitable for use in a household kitchen. For example, these fluid dispensing systems usually occupy a large amount of space, are unsightly, and detract from the stylistic design of a kitchen. Further, it is often difficult to remove and replace one or more empty water bottles from the fluid dispensing systems without heavy and strenuous lifting by the user. A general need exists for easy and efficient access to bottled water without compromising the aesthetic value or spatial limitations of the user's kitchen.

### SUMMARY

Briefly, according to one aspect of the present invention, an appliance for dispensing a liquid to a user, includes an appliance base cabinet having an enclosure positioned under a counter that is fixed to a wall. The appliance base cabinet includes a support member that is moveable relative to the counter. A dispenser spigot is coupled to the appliance base cabinet at a suitable distance below the counter to allow a user dispense water via the dispenser spigot. A liquid storage tank is supported by the support member having an opening for out-flow of the liquid. The liquid storage tank is accessible for removal or installation when the support member is moved away from the kitchen counter. The appliance further includes an intermediate reservoir within the appliance base cabinet under the kitchen counter coupled to the opening of the liquid storage tank through which the liquid out of the liquid storage tank is channeled to the dispenser spigot.

According to some of the more detailed features of the invention, the liquid storage tank is oriented in at least one of an inverted position, upright position or slanted position relative to ground. According to another embodiment, the appliance further includes a pump that pumps the liquid out of the liquid storage tank. According to a further embodiment, the counter is a kitchen counter and/or a bar counter.

According to other more detailed features of the invention, the intermediate reservoir may be one of a tube, pipe, conduit or liquid channel. According to an alternative embodiment, the intermediate reservoir may be a cistern, a receptacle that receives and holds the liquid. According to a further embodiment, the intermediate reservoir may be positioned below the liquid storage tank.

According to another more detailed feature of the invention, the liquid storage tank may be oriented in an inverted position to couple to the intermediate reservoir. The liquid storage tank may include a membrane seal that covers the opening to prevent out-flow of liquid when the liquid storage tank is in the inverted position. The liquid storage tank may further include a piercing device positioned within the intermediate reservoir creating an aperture through the membrane seal to enable the flow of liquid from the liquid storage tank into the intermediate reservoir. According to a further embodiment, the piercing device may be a spike to puncture the membrane seal.

According to still more detailed features of the invention, the dispenser spigot dispenses liquids having at least two different temperatures. According to another embodiment, the appliance may further include a chilling device positioned between the intermediate reservoir and the dispenser spigot to cool the liquid to a pre-determined temperature. According to a further embodiment, the appliance may include a heating device positioned between the intermediate reservoir and the dispenser spigot to heat the liquid to a pre-determined temperature.

According to yet another detailed feature of the invention, the appliance may include a hot water valve, a cold water valve and a room temperature valve to deliver cold, hot and room-temperature liquid to the dispenser spigot. According to a further embodiment, the appliance may include a manifold through which the liquid flows from the intermediate reservoir to the dispenser spigot. According to one embodiment, the liquid storage tank may be a two, three and/or five gallon tank.

According to another aspect of the present invention, the appliance may further include an indicator device that indicates a dispensing of the liquid through the dispenser spigot. According to a further embodiment, the appliance may include an activator device to allow the user to activate a dispensing of the liquid through the dispenser spigot. According to another embodiment, the activator device may be an electrically activated interface for the user to activate a dispensing of the liquid through the dispenser spigot

According to still another aspect of the invention, the appliance base cabinet may include a child lock-out device.

### BRIEF DESCRIPTION OF THE DRAWINGS

The present invention will be more readily understood from the following detailed description when read in conjunction with the accompanying drawings, in which:

FIG. 1 is a front view of the liquid dispensing appliance positioned beneath a kitchen counter according to an exemplary embodiment of the present invention.

FIG. 2 is a perspective view of the liquid dispensing appliance of FIG. 1.

FIG. 3 is an exploded view of the liquid dispensing appliance of FIG. 2.

FIG. 4A is a side view of the liquid dispensing appliance of FIG. 2.

FIG. 4B is a top view of the liquid dispensing appliance of FIG. 2.

FIG. 5 is a front view of one example of an electronic user interface for the liquid dispensing appliance of FIG. 2.

FIG. 6 is a perspective view of the liquid dispensing appliance of FIG. 2 positioned beneath a kitchen counter.

### DETAILED DESCRIPTION

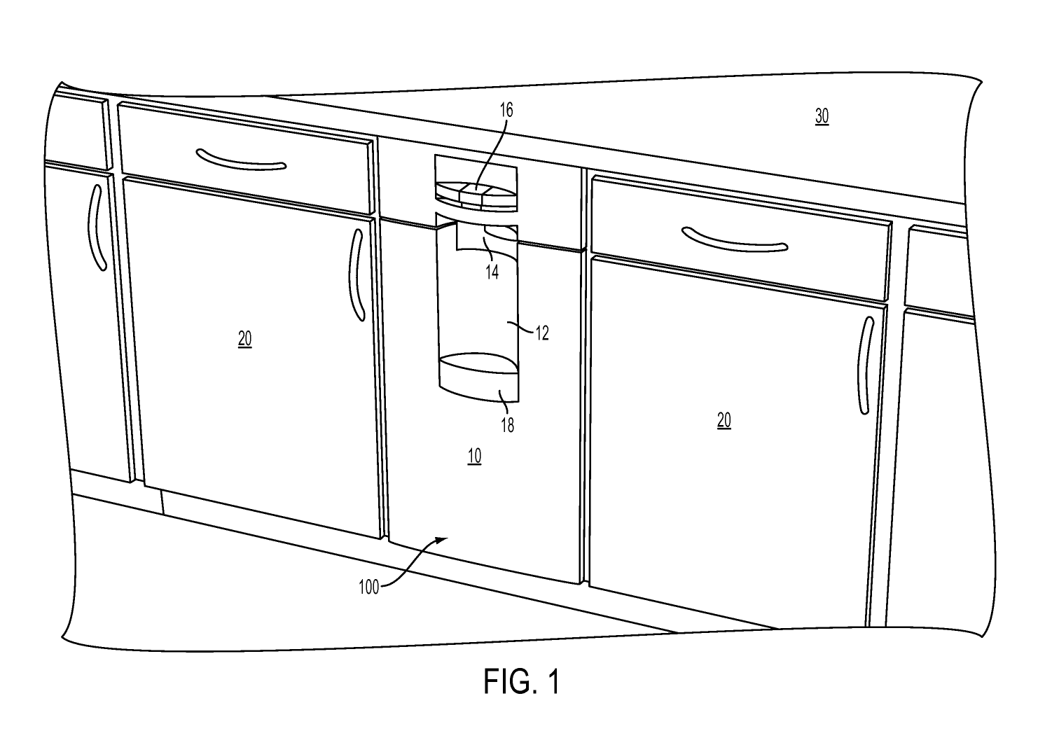

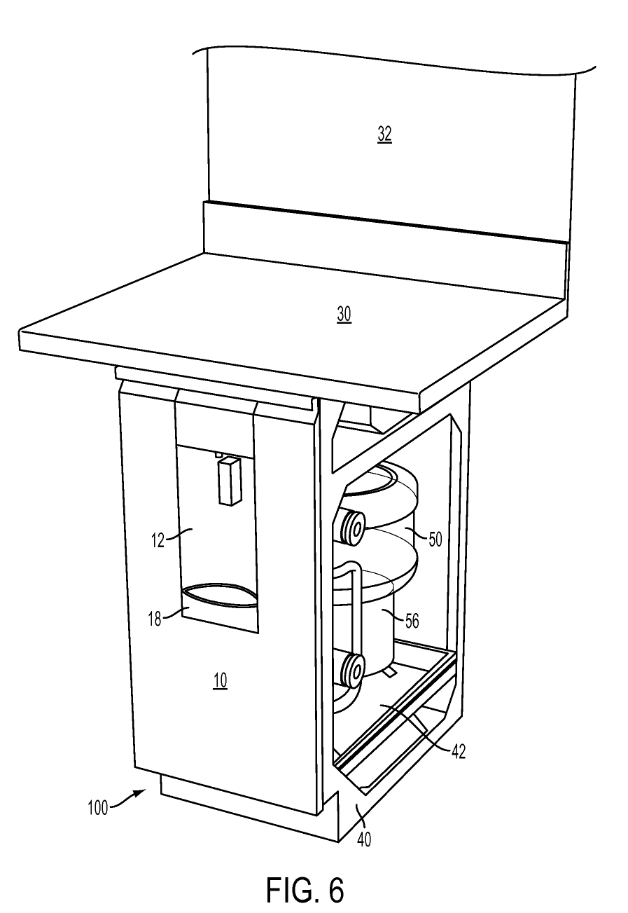

Referring to FIG. 1, the present invention relates generally to a liquid dispensing appliance 100 that fits under a kitchen counter 30 within a suitably sized cabinet opening (for example, a standard base cabinet opening). The counter 30 may be a kitchen counter and/or a bar counter and may further be fixed to a wall 32, as shown in FIG. 6. In this way, the present invention allows for integration of the liquid dispensing appliance 100, i.e. a liquid dispensing appliance base cabinet, with other kitchen appliances, thereby providing a uniform and aesthetic appearance to the kitchen, as well as convenience for dispensing a liquid, for example water, in such kitchen.

The size of the liquid dispensing appliance 100 can be specified according to United States or international standards that govern household appliances, for example standards specified by American National Standards Institute (ANSI) or the Association of Home Appliance Manufacturers (AHAM), which represents the manufacturers of household appliances and products/services associated with household appliances sold in the United States. According to one embodiment, the liquid dispensing appliance 100 may be installed within a base cabinet which may be, for example, 24-inches deep and 34.5-inches tall. Alternatively, the liquid dispensing appliance 100 may be installed into any other cabinet configuration. It is noted that most standard cabinets come in widths in the range of approximately nine-inches to approximately 36-inches, in three-inch increments.

The liquid dispensing appliance 100 of the present invention may be a modular unit within a line of one or more other modular appliances, for example a dishwasher, microwave, oven, etc. The liquid dispensing appliance 100 may be used to dispense water, however it may also be adapted to dispense alternative fluids, such as coffee, tea, juice or carbonated beverages, in a variety of configurations that save valuable kitchen space.

As shown in FIG. 1, the liquid dispensing appliance 100 may be installed to sit flush with surrounding kitchen cabinetry 20 to create a clean and uniform look. Further, a front panel 10 of the liquid dispensing appliance 100 may be customized to match the stylistic design of the kitchen. Here, as shown, the front panel 10 of the liquid dispensing appliance 100 may include a cut-out portion 12 beneath at least one dispenser spigot 14 so that a user may insert a cup, glass or bottle to fill with the dispensed liquid. The dispenser spigot 14 is positioned on the front panel 10 at a suitable distance below the counter to allow a user to dispense a liquid, for example water, in a comfortable position. A mechanically or electronically activated interface, i.e. an activation device 16, may also be added to allow a human user to operate the liquid dispensing appliance 100, to dispense liquid, select liquid temperature, and/or to limit use to specific users.

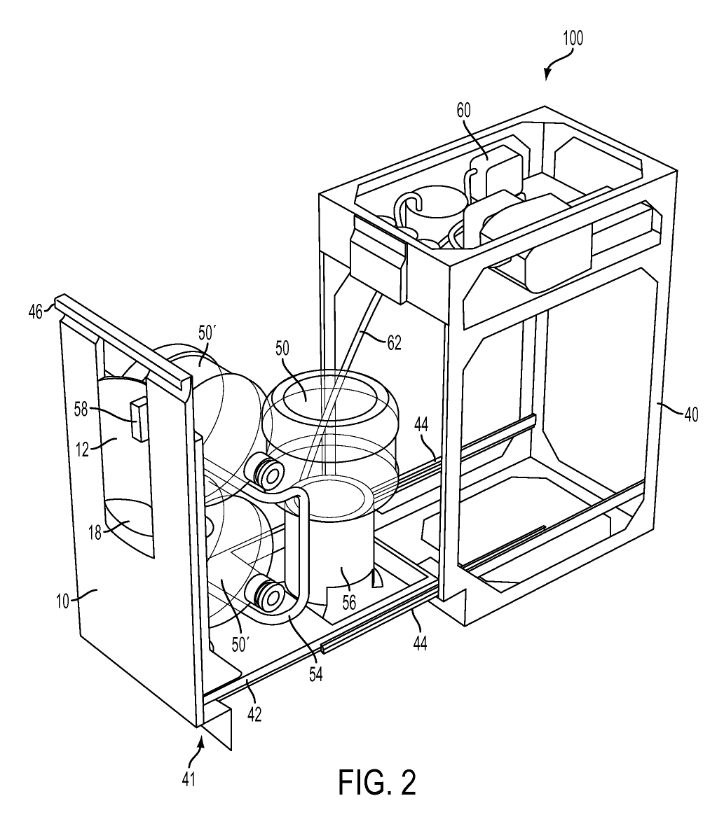

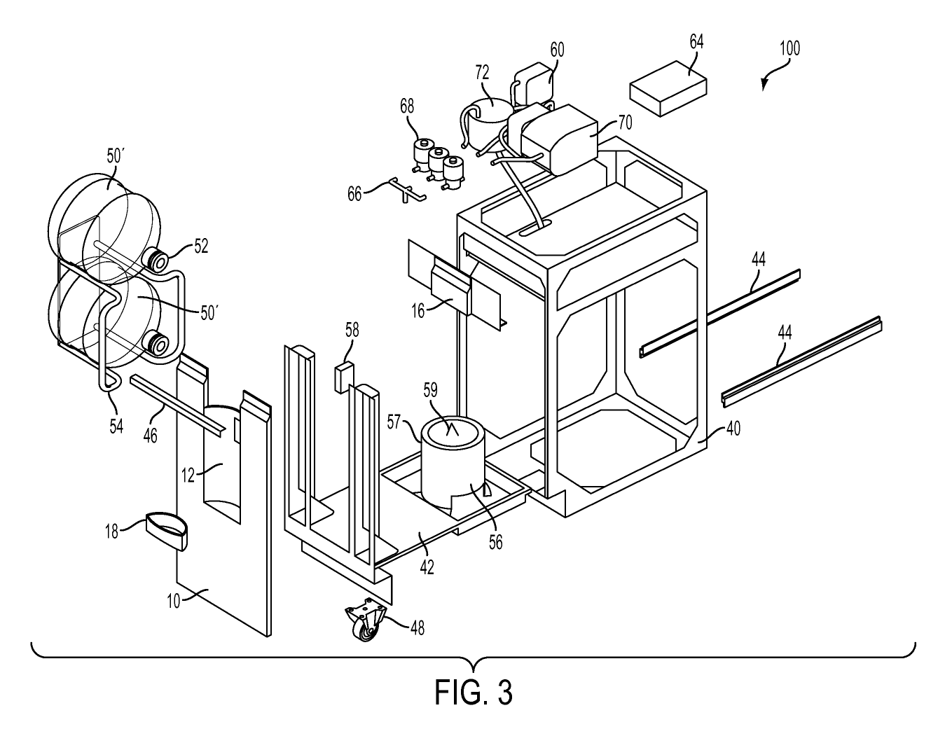

FIGS. 2 and 3 are a perspective view and an exploded view of the liquid dispensing appliance base cabinet 100 according to an exemplary embodiment of the invention. The liquid dispensing appliance base cabinet 100 comprises a frame 40 that is at least partially enclosed by a moveable enclosure 41 comprising a support member 42 and the front panel 10 which is moveably attached to the support member 42. In one embodiment, the support member 42 is moveably coupled to the frame 40 and moves along a path defined by opposing guide rails 44, which are positioned towards the bottom portion of the frame 40 as shown. It would be understood that many other moveable arrangements for coupling the support member 42 to the frame 40 are possible, including placing the guide rails 44 towards the middle or top portions of the frame. In this way, the support member 42 can be pulled out via a handle 46 that is fixed to the front panel 10 for accessing the inside of the enclosure 41. In one embodiment, the support member 42, which is moveable relative to the kitchen counter 30, comprises a base member that moves along the guide rails 44 via drawer slides, like a drawer. This arrangement provides a convenient way for removing and installing liquid storage tanks 50. According to another embodiment, the liquid dispensing appliance base cabinet 100 is sized to fit in a standard kitchen cabinet opening. However, the liquid dispensing base cabinet 100 may also be sized to a non-standard specification.

In another arrangement, the support member 42 and front panel 10 may move along the guide rails 44 via suitably positioned wheels. The enclosure 41 of the invention may also slide in and out from under the kitchen counter 30 via casters 48, as shown in FIG. 3. The casters 48 may be coupled to the bottom surface of the support member 42, as shown, and adapted to move on the kitchen floor. In this way, the handle 46 on the front panel 10 allows the user to easily pull the enclosure 41 of the liquid dispensing appliance base cabinet 100 away from the kitchen counter 30, for accessing inside the enclosure 41 which houses the tank of the dispensed liquid.

According to a further embodiment, the liquid dispensing appliance base cabinet 100 may include a child lock-out device for the protection of small children and household pets that may be present in the kitchen area. For example, as shown in FIG. 3, an interlock trigger 58 may secure the front panel 10 to the frame 40 to prevent an unauthorized or inexperienced user from pulling the enclosure 41 out of the framework 40.

In one embodiment, the tank of the dispensed liquid comprises one or more liquid storage tanks 50, which may be sized to standard or non-standard specifications. According to one embodiment, the liquid storage tank 50 may be any standard storage tank, such as a two, three and/or five gallon tank. The liquid storage tank 50 includes an opening to enable out-flow of liquid when in use. A membrane seal 52, for example a puncture sealed cap, may cover the opening to prevent the flow of liquid out of the liquid storage tank 50 prior to use and to prevent loading spills during installation. The liquid storage tank 50 may be supported on the support member 42 and made accessible for removal or installation when the support member 42, or the rolling enclosure 41, is slid away from the kitchen counter 30. Alternatively, the liquid storage tank 50 could be mounted on the front panel 10 for similar accessibility when the rolling enclosure 41 is slid out from the kitchen counter 30.

According to one embodiment, as shown in FIGS. 2 and 3, the liquid storage tank 50 comprises an inverted liquid storage tank, such that the liquid, for example water, flows out of the tank with gravity. In this embodiment, the inverted liquid storage tank 50 may be supported on the support member 42, e.g. the base plate, via an intermediate reservoir, as further described below. In this embodiment, the liquid dispensing device 100 does not use a siphon tube allowing for more convenient and hygienic loading of the inverted liquid storage tank 50. However, other arrangements for the liquid storage tank 50 may be used. For example, the liquid storage tank 50 may be situated in an inverted position, an upright position, a horizontal position and/or a slanted position relative to the ground. In these arrangements, the liquid dispensing appliance 100 may include the use of a siphon tube. The support member 42 may be suitably designed to support the liquid storage tank 50 in any orientation.

According to one embodiment, a spare storage rack 54 allows for storing one or more spare storage tanks 50′ on the support member 42. This feature provides additional ease when removing and replacing an empty liquid storage tank 50.

According to an embodiment, the intermediate reservoir comprises a cistern 56, positioned on the support member 42, that interfaces with the liquid storage tank 50 as a receptacle for receiving and holding liquid out of the inverted storage tank 50. A piercing device 59 positioned within the cistern 56 creates an aperture through the membrane seal 52 when the inverted liquid storage tank 50 is coupled to the cistern 56 to enable the flow of liquid out of the inverted storage tank 50 and into the cistern 56. According to one embodiment, the piercing device 59 may comprise a spike, barb or nail-like element to puncture the membrane seal. According to another embodiment, the cistern 56 may further include a sealing component 57 to prevent water from spilling out of the cistern 56 and into the enclosure 41, thus creating a “no spill” system.

However, the intermediate reservoir need not comprise a cistern, as shown in FIGS. 2 and 3. Instead, the intermediate reservoir may comprise a tube, pipe, conduit, siphon tube or any other liquid channel to convey the liquid from the liquid storage tank 50 to the dispenser spigot 14. According to one embodiment, the intermediate reservoir may be positioned below the liquid storage tank 50.

In one embodiment, the liquid dispensing appliance 100 further includes a pump 60 that pumps the liquid through a tube 62 from the cistern 56 to a dispenser spigot 14. According to one embodiment, the pump 60 is located above the inverted liquid storage tank 50. According to another embodiment, the pump 60 and other electrical equipment, for example, an electronics module 64 shown in FIG. 3, may be fixedly-mounted to the enclosure 41.

According to a further embodiment, the pump 60, for example an on-demand pump, pumps the liquid from the cistern 56 to a manifold 66, as shown in FIG. 3. This manifold 66 allows the liquid to pass to a valve 68 (i.e. a room temperature valve) or, alternatively, to a chilling device 70 to a cold water valve 68 or to a heating device 72 to a hot water valve 68. The chilling device 70, for example a thermoelectric chiller, and the heating device 72, for example a small heating vessel, may cool and heat the liquid to a respective pre-determined temperature.

The liquid may subsequently pass from the room temperature, hot water and/or cold water valve 68 through another short manifold (not shown) to the dispenser spigot 14 where the liquid is dispensed to a user. Thus, according to one embodiment, a single dispenser spigot 14 may dispense liquids having at least two different temperatures. Alternatively, three separate dispenser spigots may dispense hot, cold and room temperature liquid, respectively.

The dispenser spigot 14 may be positioned on the outside of the front panel 10 for easy access to a user. For example, FIG. 3 shows a front panel 10 having a cut-out portion 12 to house the dispenser spigot 14. A user may insert a glass, cup or bottle into the cut-out portion 12 to dispense the liquid into. Further, a drip tray 18 may be positioned at the bottom of the cut-out portion 12 to catch any overflow of liquid. According to one embodiment, the dispenser spigot 14 is positioned at a suitable distance below the kitchen counter 30 to enable a user to easily dispense a liquid into a container.

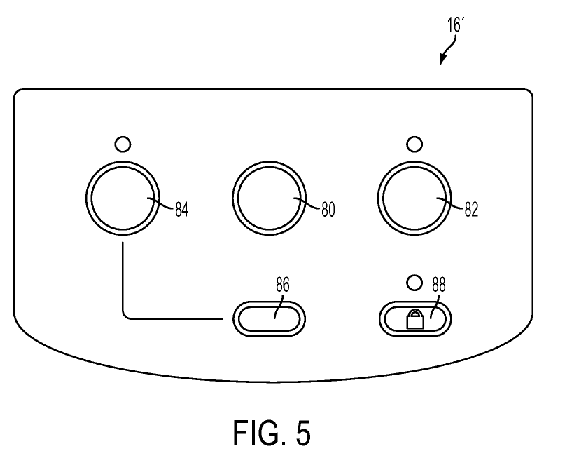

The dispenser spigot 14 may be activated by a user in response to a suitable activation device 16, or an activation interface device, for example a lever. According to one embodiment, shown in FIG. 5, the activation device 16 may comprise an electrically activated interface 16′, i.e. a control panel. The activation device 16 may be positioned on the front panel 10 of the liquid dispensing appliance base cabinet 100 below the kitchen countertop 30 so that the controls are accessible by the user at a more convenient height for operation than traditional floor-standing water coolers. Additionally, the activation device 16 may be integrated with an indicator device (not shown) that indicates to a user when a liquid is dispensing through the dispenser spigot 14.

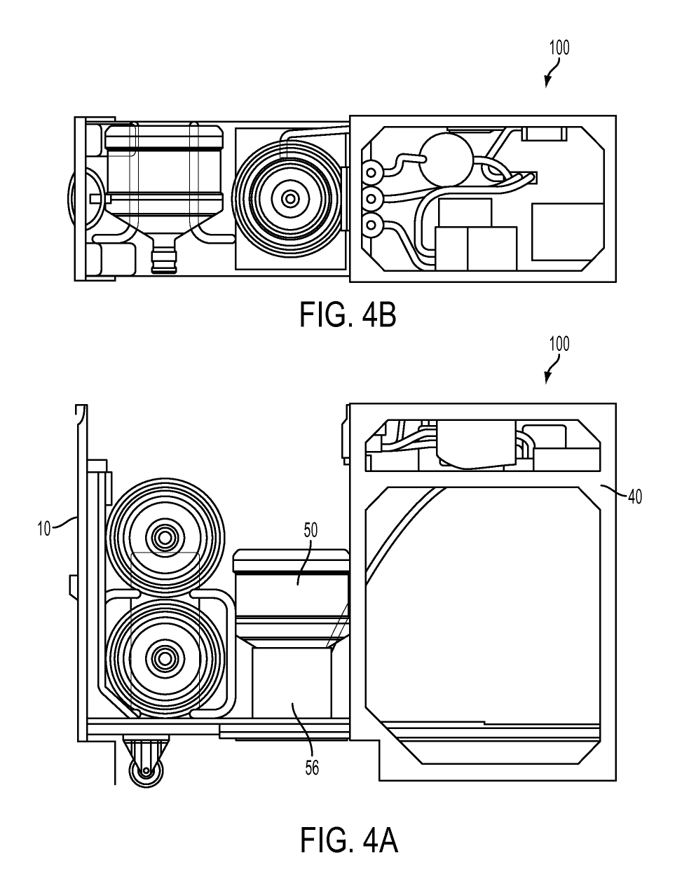

FIGS. 4A and 4B show a side and top view of the liquid dispensing appliance 100 as described above with regard to FIGS. 2 and 3.

FIG. 5 is a front view of an electronic user interface 16′ according to an embodiment of the present invention. As shown, a user may press a room temperature button 80 or a cold water button 82 to dispense room temperature water or cold water, respectively. Additionally, a user may simultaneously press a hot water button 84 and a hot water interlock button 86 to dispense hot water. The additional step of pressing the hot water interlock button 86 is used to prevent a child or an inexperienced user from burning themselves by accidentally or inadvertently dispensing hot water. Along similar lines, the electronic user interface may include a child safety lock-out button 88 to prevent a child or inexperienced user from operating the liquid dispensing appliance 100 and/or pulling the enclosure 41 open from under the counter 30. A child safety lock-out button 88, for example, may need to be pressed and held for three-seconds by a user to unlock.

FIG. 6 is a perspective view of the liquid dispensing appliance 100 positioned beneath a kitchen counter 30, according to one embodiment of the present invention. FIG. 6 shows that all of the components of the liquid dispensing appliance 100 may be reduced to a small modular appliance unit that may be conveniently fitted into a custom or standard household kitchen. The liquid dispensing appliance 100 may be custom-designed to be stylistically compatible with the countertop 30, flooring, tile-work, kitchen appliances and/or cabinetry 20 of a particular kitchen. The liquid dispensing appliance 100 may further be sized as a small or larger kitchen appliance to occupy an optimal space in a household kitchen. The liquid dispensing appliance 100 may provide efficiency, value and an easy manner of providing safe drinking liquids to users of a household kitchen.

It will be understood that the above description of the present invention is susceptible to various modifications, changes and adaptations, and that the same are intended to be comprehended within the meaning and range of equivalents of the appended claims.

What is claimed is:

1. An appliance for dispensing a liquid to a user, comprising:
an appliance base cabinet comprising an enclosure positioned under a counter that is fixed to a wall, the appliance base cabinet having a support member that is moveable relative to the counter;
at least one dispenser spigot coupled to the appliance base cabinet at a suitable distance below the counter to allow a user dispense water via the at least one dispenser spigot;
at least one liquid storage tank supported by the support member having an opening for out-flow of the liquid, wherein the at least one liquid storage tank is accessible for removal or installation when the support member is moved away from the kitchen counter; and
an intermediate reservoir within the appliance base cabinet under the kitchen counter coupled to the opening of the at least one liquid storage tank through which the liquid out of the at least one liquid storage tank is channeled to the at least one dispenser spigot.

2. The appliance according to claim 1, wherein the at least one liquid storage tank is oriented in at least one of an inverted position, upright position or slanted position relative to ground.

3. The appliance according to claim 1, further comprising a pump that pumps the liquid out of the at least one liquid storage tank.

4. The appliance according to claim 1, wherein the counter comprises at least one of a kitchen counter or a bar counter.

5. The appliance according to claim 1, wherein the intermediate reservoir comprises one of a tube, pipe, conduit or liquid channel.

6. The appliance according to claim 1, wherein the intermediate reservoir comprises a cistern comprising a receptacle that receives and holds the liquid.

7. The appliance according to claim 1, wherein the intermediate reservoir is positioned below the at least one liquid storage tank.

8. The appliance according to claim 1, wherein the at least one liquid storage tank is oriented in an inverted position to couple to the intermediate reservoir, the at least one liquid storage tank including a membrane seal that covers the opening to prevent out-flow of liquid when the at least one liquid storage tank is in the inverted position and a piercing device positioned within the intermediate reservoir creating an aperture through the membrane seal to enable the flow of liquid from the at least one liquid storage tank into the intermediate reservoir.

9. The appliance according to claim 8, wherein the piercing device comprises a spike to puncture the membrane seal.

10. The appliance according to claim 1, wherein the at least one dispenser spigot dispenses liquids having at least two different temperatures.

11. The appliance according to claim 1, further comprising a chilling device positioned between the intermediate reservoir and the at least one dispenser spigot to cool the liquid to a pre-determined temperature.

12. The appliance according to claim 1, further comprising a heating device positioned between the intermediate reservoir and the at least one dispenser spigot to heat the liquid to a pre-determined temperature.

13. The appliance according to claim 1, further comprising a hot water valve, a cold water valve and a room temperature valve to deliver cold, hot and room-temperature liquid to the at least one dispenser spigot.

14. The appliance according to claim 1, further comprising at least one manifold through which the liquid flows from the intermediate reservoir to the at least one dispenser spigot.

15. The appliance according to claim 1, wherein the at least one liquid storage tank comprises at least one of a two, three or five gallon tank.

16. The appliance according to claim 1, further comprising an indicator device that indicates a dispensing of the liquid through the at least one dispenser spigot.

17. The appliance according to claim 1, further comprising an activator device to allow the user to activate a dispensing of the liquid through the at least one dispenser spigot.

18. The appliance according to claim 17, wherein the activator device comprises an electrically activated interface for the user to activate a dispensing of the liquid through the at least one dispenser spigot.

19. The appliance according to claim 1, wherein the appliance base cabinet includes a child lock-out device.
